(19) United States
(12) Patent Application Publication
(10) Pub. No.: US 2002/0004380 A1
(43) Pub. Date: Jan. 10, 2002

(54) Depositing method and arrangement

(75) Inventors: Carsten Thormod Pedersen, Ballerup (DK); Soren Kamaric Riis, Ballerup (DK); Thomas Jul, Copenhagen (DK)

Correspondence Address: PILLSBURY WINTHROP LLP, 1600 TYSONS BOULEVARD, MCLEAN, VA, 22102, US

(73) Assignee: Nokia Networks Oy, Espoo (FI)

(21) Appl. No.: 09/870,277

(22) Filed: May 30, 2001

Related U.S. Application Data
(63) Continuation of application No. PCT/FI99/00995, filed on Dec. 2, 1999.

(30) Foreign Application Priority Data
Dec. 10, 1998 (FI) 982678

(51) Int. Cl. H04M 11/00

(52) U.S. Cl. 455/406; 455/405

(57) ABSTRACT

In order to make the change of subscription type easy for subscribers using prepaid subscriptions, information indicating the types of a last used voucher and a new voucher is maintained. This information can be used to determine the types of said vouchers, to detect a change of subscription type and to select the proper way to update the credit.

### CROSS-REFERENCE TO RELATED APPLICATIONS

This application is a continuation of pending PCT International Application PCT/FI99/00995, filed Dec. 2, 1999, which designated the U.S. and was published under PCT Article 21(2) in English, and which is incorporated herein by reference.

### FIELD OF THE INVENTION

The present invention relates to a method and arrangement for updating the amount of credit available to prepaid subscribers. A prepaid subscriber refers to a subscriber using a prepaid subscription, i.e. a subscriber who has paid in advance.

### BACKGROUND OF THE INVENTION

In mobile communications systems, such as the GSM, use of prepaid SIM (Subscriber Identity Module) cards is increasing. Prepaid SIM cards relieve the network operators of credit losses. They enable parents to set an upper limit for the telephone bill beforehand. As a third benefit, they enable subscribers roaming abroad to pay for their local calls at local tariffs, whereas using the SIM card of their home operator results in paying international tariffs for connections to their home network and back.

Some operators allow the subscribers to call an Interactive Voice Response (IVR) service through which the service subscribers can check their account balance and add more money to their accounts. Account balance is also called credit. Money is added by means of vouchers. Some of the operators sell different types of vouchers, which differ from each other e.g. in the price of a “call unit”.

A problem with the current IVR solution is that it does not support the change of voucher type. When a subscriber is adding money to his/her account, the value of the voucher is added to his/her current credit. This is not a problem when the previous voucher and the new voucher are of the same type. If the vouchers are of a different type, the value of the new voucher should not be added to the current credit because the properties of call units differ from one another. For this reason every night a dedicated person has to check the database to find out all subscribers who have changed their voucher type, and to update the credits of said subscribers. A problem with this method is that it is slow, susceptible to errors and laborious. Furthermore, a subscriber who has changed his/her voucher type, may receive false information if he/she inquires about his/her credit before the manual updating is done.

### SUMMARY OF THE INVENTION

The object of the invention is to overcome the above stated problems. The object of the invention is achieved with a method, an arrangement and a network element which are characterized by what is disclosed in the independent claims. The preferred embodiments of the invention are set forth in the dependent claims.

The invention is based on maintaining information about types of vouchers, on comparing the type of a deposit voucher with the type of a last used voucher and on selecting the way to make a deposit depending on the result of the comparison.

The advantages of the invention are that the credit is always automatically updated correctly and no amendments are needed afterwards. Therefore the change of subscription type is very easy for both prepaid subscribers and operators. Besides, the subscriber will obtain the updated amount of his/her current credit immediately after the deposit is made.

In one embodiment of the invention, when the vouchers are of a different type, the credit is updated to be only the value of the new voucher. A further advantage of this embodiment is that it provides a simple way to update the credit when the voucher type changes.

Yet in one embodiment of the invention, when the vouchers are of a different type, the credit is updated by multiplying the current credit with a factor the value of which is determined on the basis of the voucher types, the credit after depositing being the sum of the multiplication and the value of the new voucher. A further advantage of this embodiment is that the operator can offer a flexible way to change the voucher type so that the current credit need not be totally deleted, but it may be adjusted to the new voucher type.

Yet in another embodiment of the invention the system asks the subscriber whether he/she approves that his/her current credit or part of it is lost when the profile is changed. A further advantage of this embodiment is that the subscriber changing the voucher type no longer needs to keep in mind that the unused credit will be lost, or whether his/her last voucher was of the same type as the new one. Besides, he/she can deny the change of type, and thus save his/her old credit. This embodiment actually protects the subscriber.

### BRIEF DESCRIPTION OF THE DRAWINGS

The invention will be described in further detail in the following by means of preferred embodiments and with reference to the accompanying drawings, in which

FIG. 1 is a block diagram showing some relevant network elements;

FIG. 2 is a flow chart illustrating a first preferred embodiment;

FIG. 3 is a flow chart illustrating a second preferred embodiment; and

FIG. 4 is a functional model illustrating exchange of information between different network elements.

### DETAILED DESCRIPTION OF THE INVENTION

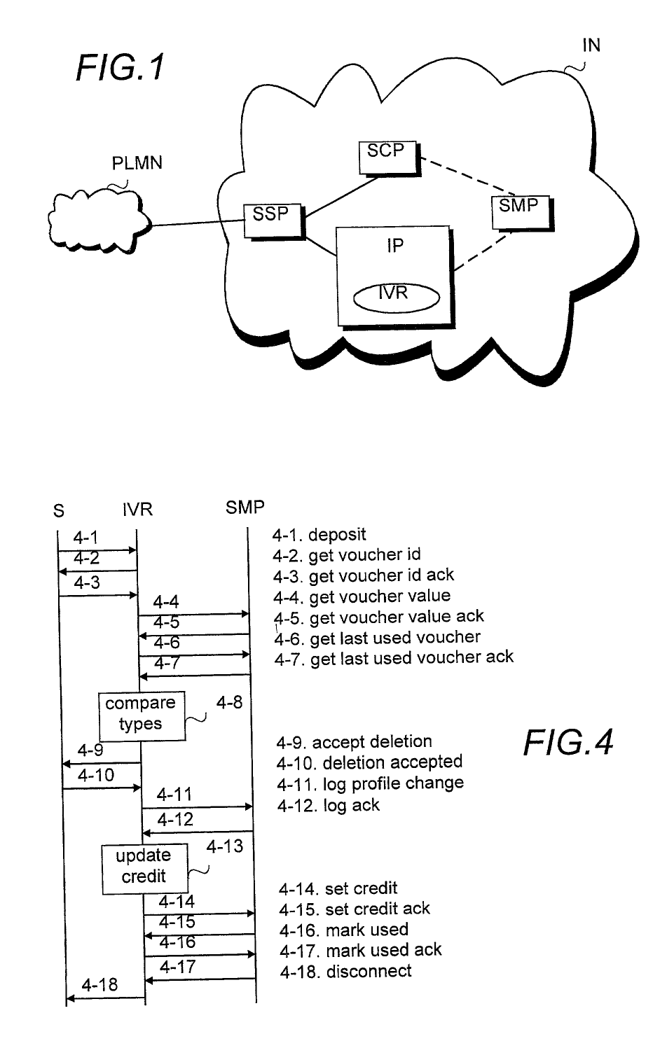

FIG. 1 is a block diagram of a telecommunications system equipped with an arrangement according to a preferred embodiment of the invention. The telecommunications network is assumed to be a public land mobile network PLMN, yet without limiting the invention to a particular network. The invention can be used in any telecommunication system where prepaid subscribers can add money to their account. This embodiment illustrated in FIG. 1 makes use of Intelligent Network technology. An intelligent network (IN) is able to provide a subscriber of a telecommunications network, such as a wired network or a mobile telephone network, with a plurality of various services. An example of such an intelligent network is described in recommendations of the ITU-T Q-1200 series, of which Q-1210 to Q-1219 define a set of features known as CS-1 (Capability Set 1) and, correspondingly, Q-1220 to Q-1229 define a set of features CS-2. The invention and its background will be described using the terminology of recommendation ETS 300 374-1 CorelNAP, but the invention can also be employed in intelligent networks implemented according to other intelligent network standards.

FIG. 1 shows some elements of an intelligent network which are relevant to the understanding of the invention, such as elements known as intelligent peripherals IP. Usually an IP is associated with a specialized resource function SRF which is an interface for network mechanisms associated with interaction with a subscriber. Thus an IP may comprise e.g. more advanced speech handling functions than exchanges in general. The IVR application is usually located in the IP. The IVR application, also called the PrePaid SIM IVR application, is an interactive voice response application that allows the subscriber to add (deposit) money to PrePaid SIM accounts by entering the number of a prepaid voucher. Below the IVR application will be called simply the IVR. The IVR Voicetek Generation may be used as an execution environment for the IVR.

The IP is connected to an SSP, using for example ISUP (ISDN User Part) signalling and one or more voice transports. The SSP (Service Switching Point) is a network element performing service switching function (SSF). The SSP may be a mobile service switching centre MSC including SSF. The SSF is an interface between a conventional call control function CCF and the service control function SCF of the intelligent network. The network element performing the SCF is called a service control point (SCP). An intelligent network service is produced by the service switching point SSP inquiring instructions from the service control point SCP by means of messages to be transmitted across the SSP/SCP interface upon the encounter of detection points associated with the services. In association with an intelligent network service, a service program is started at the service control point SCP, the operation of the program determining the messages transmitted by the SCP to the SSP at each stage of a call. However, usually the SCP is not used in the service logic of the Prepaid SIM IVR application, i.e. calls to the IVR are directly routed by the CCF to the IVR on the basis of the service number.

In the example illustrated in FIG. 1, the prepaid subscriber-specific information and information about vouchers are in a database located in a service management point SMP. Alternatively, the information may be located in different databases and/or in some other network element. The subscriber specific information according to the invention comprises at least the current credit. It may also comprise information from which the type of the last used voucher can be deduced. The subscriber-specific information may also comprise information concerning the time when the voucher type was last changed. The information about vouchers comprises the numbers of valid vouchers and their value. The information about vouchers may also comprise information about voucher types. Alternatively, information about the last used voucher can be saved in the voucher information for example by marking the voucher used, which is done by adding information about the subscriber to the voucher information. The SMP may also comprise a log file which includes the amount of deleted credit along with sufficient information to identify the subscriber and, advantageously, the time when the deletion was done. The log file may also be in an external database. The IVR interfaces the SMP database through a service management interface SMI. The SMP and the IP may be connected e.g. through a local area network (LAN) using the TCP/IP (Transmission Control Protocol/Internet Protocol). The connection between the IP and the SMP illustrated by a dashed line only represents a management connection without any signalling connection.

The present invention can be implemented into existing network elements. They all have processors and memory with which the inventive functionality described below may be implemented. The functions described below may be located in one network element or some of them may be in one element and the others in other elements, regardless of how they are located in the examples used to illustrate the invention.

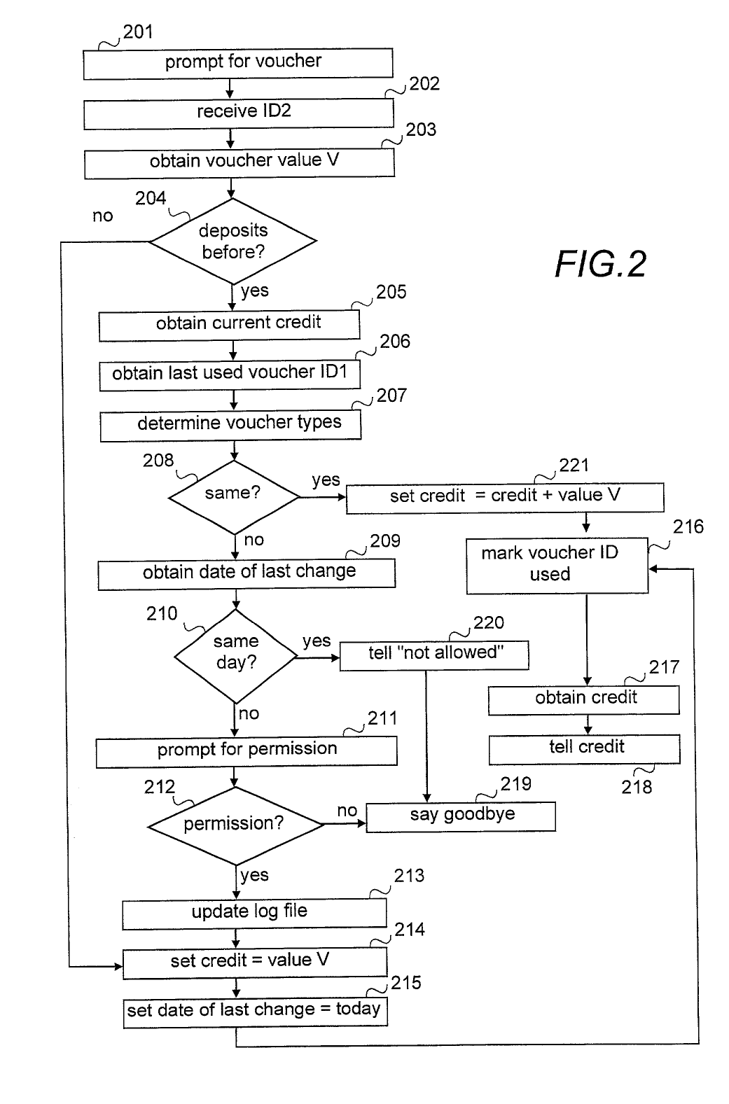

FIG. 2 is a flow chart illustrating the functionality of the IVR in a first preferred embodiment of the invention. In this example it is assumed, for the sake of clarity, that the new voucher is valid and that all necessary information is obtained. It is also assumed that in a case of subscription change, e.g. when the voucher types are not the same, the current credit is removed/deleted (set to zero). In the first preferred embodiment of the invention the voucher identification numbers are used to identify the voucher type; for example, when two types of vouchers are used, the identification numbers of type 1 are on list 1, the missing numbers representing type 2. In other embodiments each type can have its own type list or the first two numbers of the identification number, for example, indicate the type of the voucher. Although it is essential to determine the type of the voucher, it is, however, irrelevant to the invention how the voucher type is determined.

FIG. 2 shows a situation where a subscriber has bought a voucher from a shop, called the IVR and selected to deposit the voucher. The subscriber is assumed to be a prepaid subscriber, otherwise he/she cannot make a deposit. It is further assumed, that the IVR checks at the beginning of the call whether the caller is a prepaid subscriber and, if he/she is not, then the call is disconnected or connected to customer service. FIG. 2 begins in step 201, where the IVR prompts the subscriber for voucher identification ID. The voucher identification number ID2 is received in step 202. The validity of the voucher is checked (not shown in FIG. 2) and, after that, in step 203 the IVR obtains the value V of the voucher. In step 204 is then checked whether the subscriber has made any deposits before. If the subscriber has made deposits before, the IVR obtains the subscriber's current credit in step 205. In step 206 the IVR also obtains the identification number ID1 of the last used voucher and in step 207 it determines the types of the vouchers by using the identification numbers and going through the list(s).

After the voucher types are determined, the IVR checks in step 208 whether the vouchers are of the same type. If they are not, the subscriber makes a subscription change, i.e. changes the voucher type. Since in the first preferred embodiment of the invention the operator does not want the subscriber to change voucher type more than once a day, the IVR obtains in step 209 the date of last change, i.e. the date when the voucher type was last changed and checks (in step 210) whether the date is the same as the date of the updating. If it is not, the change is allowable. In other embodiments there may be different rules or a rule to determine if the change is allowable and the determining is done by adapting it to the requirements of the rule(s) as stated above. One example of the rules is that a change of profile is allowed only on those days when the subscriber has not yet deposited anything. Another example is that a deposit must be followed by a charged call before a new deposit can be made. This last rule may also be applied to normal deposits without change of type.

If the change is allowable (step 210), the IVR prompts in step 211 for permission to change the type. With this prompting the subscriber is informed of his/her current credit and also reminded that he/she has bought a voucher of a different type and that therefore, if he/she wants to continue the depositing process, the current credit will be lost. Finally, the subscriber is prompted to provide either a permission to continue sign or a discontinue sign. In other embodiments of the invention it is possible to check whether the credit is zero before entering step 211 and if the credit is zero, to skip step 211.

If the permission is received in step 212, the log file is updated in step 213 by adding the following information: the amount of deleted credit; the subscriber of the deleted credit; the time it was deleted; and the voucher type used when the deleted credit was deposited. In this example the current credit is deleted when the voucher type is changed. The IVR then sets in step 214 the value V of the voucher to be the current credit and in step 215 it sets the date of the updating to be the date of the last change. The IVR then continues according to prior art: it marks in step 216 the voucher ID2 used, obtains in step 217 the current credit and the credit in step 218. The voucher is marked used in step 216 by adding subscriber information to the voucher identification number and by entering the date of the deposit as the “used date” in the first preferred embodiment.

If the subscriber does not want to lose the current credit, permission is not received in step 212 and the IVR quits without doing any updating and gives an audio message saying goodbye in step 219. The call is disconnected.

If the date when the voucher type was last changed is the same as the date of the updating (step 210), the IVR gives in step 220 an audio message telling that updating is not allowed on that day and continues in step 219 by giving an audio message saying goodbye.

If the vouchers are of the same type (step 208), the IVR sets in step 221 the credit to be the sum of the current credit and the value V of the voucher and then continues in step 216 by marking the voucher used as described above.

If the subscriber has not made any deposits before (step 204), his/her credit is zero, and therefore the IVR proceeds directly to step 214 by setting the credit to be the value V of the voucher as described above.

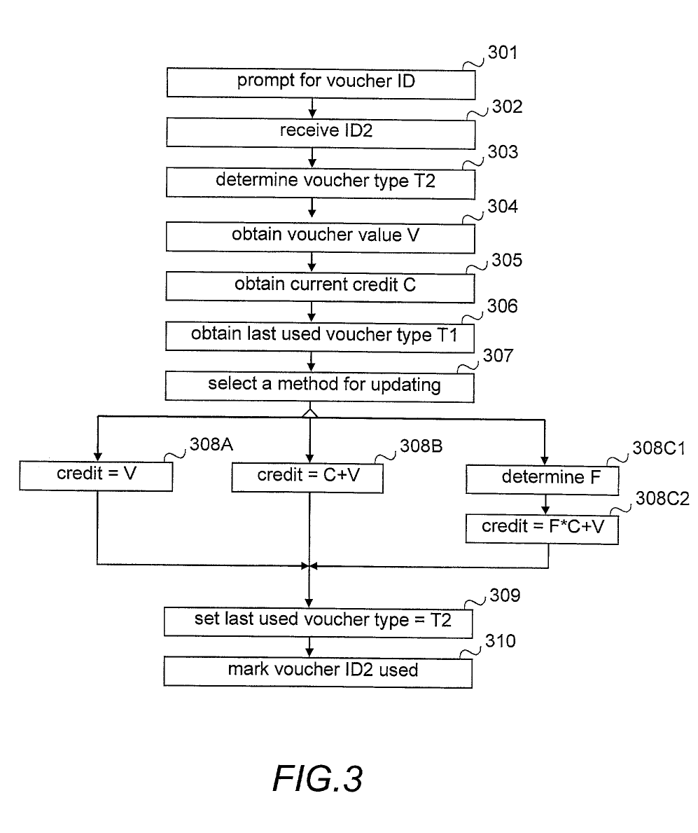

FIG. 3 is a flow chart illustrating a function of the IVR application in a second preferred embodiment of the invention. Also in this example it is assumed, for the sake of clarity, that the new voucher is valid, that all the necessary information is obtained and that the calling subscriber is a prepaid subscriber. In the second preferred embodiment of the invention the first number of the voucher identification number is used to identify the type of the voucher.

FIG. 3 begins from the same step as FIG. 2: a subscriber has bought a voucher from a shop, called to the IVR and selected to deposit the voucher. In step 301, the IVR prompts the subscriber for voucher identification ID. The voucher identification number ID2 is received in step 302 and the type T2 of the voucher is determined in step 303 from the first number of the ID2. The validity of the voucher is checked (not shown in FIG. 3) and after that, the IVR obtains the value V of the voucher in step 304, as described in connection with FIG. 2. The IVR then obtains in step 305 the subscriber's current credit and in step 306 the last used voucher type T1. On the basis of the types T1 and T2 the IVR selects the method of updating in step 307. If the type T1 is not found in step 306, and the current credit is not found in step 305 either, the subscriber has never made any deposits and, therefore, his/her credit is set to be the value V of the voucher in step 308A. If the vouchers are of the same type (that is T1=T2), in step 308B the value V of the voucher is added to the current credit C and the result is set as the credit. If the vouchers are of a different type, the value of the factor F is determined in step 308C1; the current credit C is multiplied with the factor F; the product is added to the value V of the voucher; and the sum is set in step 308C2 to be the credit. The value of the factor can always be zero or, if type T1 call units are more expensive than type T2 call units, the value of the factor can be one or, if type T1 call units are half the price of type T2 call units, the value of the factor can be 0.5. The operator may predetermine the values of the factor for different combinations of T1 and T2. The invention does not limit this freedom, as long as at least one value of the factor is determined with this multiplying method.

After the credit is updated in one of the above described ways, the IVR sets in step 309 the last used voucher type to be T2. After that the IVR continues according to prior art by marking the voucher ID2 used in step 310.

The steps have not been set out in an absolute time sequence in FIGS. 2 and 3. Some of the above described steps may take place simultaneously, or in a different order, or some of the steps may be skipped, e.g. the step 210. It is also possible to add new steps not shown in the Figures, for example different prompts and/or audio messages can be added to FIG. 3. It is also possible to combine steps from FIG. 2 and FIG. 3 when making a new embodiment. It is also possible, that when the IVR receives an incoming call, it checks whether the caller is a prepaid subscriber, obtains the current credit and gives an audio message telling the current credit, if the caller is a prepaid subscriber or gives an informative audio message, if the caller is not a prepaid subscriber. In these embodiments the steps 204 and 223 or 308A are not needed. What is essential is that the change in the voucher type is detected e.g. by comparing the types of the last used voucher and the new voucher, and that the decision on how to update the credit depends on whether the change in voucher type is detected (e.g. is based on the result of the comparison).

The functional model of FIG. 4 is another way to illustrate the updating of a subscriber's credit by applying a preferred embodiment of the invention. The Figure does not illustrate actual signalling, since communication between the IVR in the IP and the SMP is usually TCP/IP LAN via SMI. Besides, there usually exists no signalling connection between the IP and the SMP. Also communication between a subscriber's mobile station and the IVR in the IP is conveyed by DTMF or voice. In this example, it is assumed that the credit is updated under IN control, but this is not necessary to the invention. Another assumption made here is that the IN is also responsible for maintaining a record of the credit available for the prepaid SIM card. Further assumption made here is that the SCP does not control calls made to the IVR, since they are routed directly to the IP on the basis of the service number. It is also assumed, that the subscriber is a prepaid subscriber who is going to make a subscription change, i.e. change the voucher type.

In the scenario shown in FIG. 4 the subscriber has bought a new voucher, called the IVR and now sends event 4-1 (deposit) to the IVR. The IVR asks the identification number of the voucher in event 4-2 (get voucher id). The subscriber gives (by DTMF selection) the identification number of the voucher to the IVR in event 4-3 (get voucher id ack). The IVR then asks the SMP for the value of the voucher in event 4-4 (get voucher value). The SMP checks the value of the voucher from its voucher related information with the help of the identification number of the voucher it obtained in event 4-4 and returns the value to the IVR in event 4-5 (get voucher value ack). The IVR then asks the SMP the identification number of the last used voucher in event 4-6 (get last used voucher). In other embodiments the IVR may ask the type of the last used voucher. The SMP checks from its subscriber related information the identification number of the last used voucher and sends the identification number in event 4-7 (get last used voucher ack) to the IVR.

The IVR then determines the types of the last used voucher and the new voucher from their identification numbers by going through a list or lists with which the types can be determined. As stated above, the IVR may alternatively determine the types e.g. from the first number or first two numbers in the identification number. In step 4-8 in the example illustrated in FIG. 4, the IVR compares the voucher types and finds out that the types differ from each other. So, the IVR gives an audio message to the subscriber telling that his/her profile is changed and that the current credit is set to zero if the subscriber accepts the profile change and the deletion in event 4-9 (accept deletion). In this example the subscriber accepts the deletion and sends event 4-10 (deletion accepted) to the IVR. In a response to the accepting event 4-10, the IVR sends event 4-11 (log profile change) to the SMP. This event preferably includes parameters which indicate the subscriber, the current credit, the last voucher type and the date. Event 4-11 may also include a parameter indicating the new voucher type and/or its value. The SMP updates its log file with the information it received in event 4-11 and sends an acknowledgement in event 4-12 (log ack).

The IVR updates in step 4-13 the credit to be the value of the voucher and sends the value to the SMP in event 4-14 (set credit). The SMP sets the current credit to be the value it received in event 4-14 and enters the value into the subscriber related information and sends an acknowledgement in event 4-15 (set credit ack). After this the IVR sends to the SMP event 4-16 (mark used) telling it to mark the new voucher used. The SMP marks the voucher used in its voucher related information and sends an acknowledgement in event 4-17 (mark used ack). The IVR then sends event 4-18 (disconnect) to the subscriber. The call is disconnected and the SMI connection to the SMP is closed according to known procedures. In another embodiment the IVR first asks the SMP for credit and tells the credit to the subscriber by giving an audio message before sending event 4-18 (disconnect).

In yet another embodiment the IVR may ask the SMP for the type of the new voucher and, instead of asking for the identification number in event 4-6, it may ask for the type of the last used voucher. The SMP can check its lists to determine the voucher types on the basis of the identification numbers and return the types to the IVR. Other methods may also be applied to find out the voucher type.

If event 4-10 is a “deletion not accepted” event, then after receiving it the IVR sends event 4-18 (disconnect) to the subscriber, instead of event 4-11. As a result, no deposit is made, the current credit before the updating is not lost, and the new voucher is not marked used. The situation remains as if the call would not have taken place at all.

The events and the steps in FIG. 4 have not been set out in absolute time sequence. Some of the above described steps and events may take place simultaneously or in different order, for example events 4-4 and 4-6. The events may include more information than stated above. The names of the events may differ from those set out above, or the information needed according to the invention may be sent in other events, as stated above. Also other events and steps not shown in FIG. 4 may be sent or happen between the events and steps stated above.

Although the invention is described above with reference to preferred embodiments involving only one subscriber, it is obvious for one skilled in the art, that several depositing procedures may run in parallel as long as unique channels are assigned to them to ensure that the subscribers will not get mixed. Also other prepaid service facilities than credit updating may be updated and/or taken into account when updating the credit although they are not described in detail here. One possible facility is the validity time given to a voucher.

The accompanying drawings and the description pertaining to them are only intended to illustrate the present invention. Different variations and modifications to the invention will be apparent to those skilled in the art, without departing from the scope and spirit of the invention defined in the appended claims.

That which is claimed:

1. A method for updating a subscriber's account credit in a telecommunications system where at least two different types of vouchers can be used for making deposits in the account;
the method comprising the steps of:
defining at least two different ways of updating the credit;
maintaining information indicating the type of a first voucher currently used;
receiving a deposit identifying a second voucher;
determining the type of the second voucher; and
selecting the way of updating the credit on the basis of the types of the first voucher and the second voucher.

2. The method of claim 1, further comprising the steps of:
checking whether the first voucher and the second voucher are of the same type; and
updating the credit by adding the value of the second voucher to the credit, if said vouchers are of the same type; or
updating the credit by setting the credit to be the value of the second voucher, if said vouchers are of a different type.

3. The method of claim 1, further comprising the steps of:
checking whether the first voucher and the second voucher are of the same type; and
updating the credit by adding the value of the second voucher to the credit, if said vouchers are of the same type; or
determining a factor, multiplying the credit with the factor and adding the result of said multiplication to the value of the second voucher, and setting the credit to be the result of said addition, if said vouchers are of a different type.

4. The method of claim 3, wherein said factor is determined on the basis of the types of the first and the second voucher.

5. The method of claim 1 further comprising the steps of:
asking the subscriber for a permission to update the credit, if the vouchers are of a different type; and
updating the credit only if the permission is received from the subscriber.

6. The method of claim 1 wherein the types of the vouchers are determined on the basis of their identification numbers.

7. The method of claim 1, wherein the telecommunications system is a mobile telecommunications system.

8. An arrangement for updating a subscriber's account credit in a telecommunications system where the subscriber can pre-pay for his/her calls by making deposits in his/her account using at least two different types of vouchers and where the system applies a first method to update the credit, the arrangement being arranged to
detect a possible change of voucher type when the credit is updated; and,
in response to said detection, to apply a second method to update the credit.

9. The arrangement of claim 8, wherein the arrangement is further arranged, in response to said detection, to ask the subscriber for a permission to update the credit and to update the credit only in response to the permission.

10. The arrangement of claim 8, wherein the arrangement is arranged to detect said change of voucher type by determining the types of a last used voucher and a new voucher and by comparing these types.

11. The arrangement of claim 9, wherein the arrangement comprises an Intelligent Peripheral of an Intelligent Network, said Intelligent Peripheral comprising an Interactive Voice Response service through which the credits are updated.

12. A network element in a telecommunications system where a subscriber of the system can pre-pay for his/her calls by making deposits in his/her account using at least two different types of vouchers, which element includes a database or can be arranged to have access to a database, where account credit is maintained, the network element comprising
a first mechanism to determine the type of the voucher last used by the subscriber,
a second mechanism to determine the type of the new voucher which the subscriber is going to use to update his/her credit, and
a third mechanism to select a method of updating the credit among at least two different updating methods on the basis of the types of said vouchers.

13. The network element of claim 12, wherein the third mechanism is further arranged to ask the subscriber for a permission to update the credit according to the voucher type concerned in response to said vouchers being of a different type, and to update the credit only in response to a permission received from the subscriber.

14. The network element of claim 12, wherein in response to the different voucher types, the third mechanism is further arranged to determine a factor, to multiply the subscriber's current credit with said factor, to add the result of said multiplication to the value of the second voucher, and to set the credit to be the result of said addition.
